(19) United States
(12) Patent Application Publication
(10) Pub. No.: US 2022/0306508 A1
(43) Pub. Date: Sep. 29, 2022

(54) GRANULATED WATER TREATMENT PLANT SLUDGE COMPOSITION CONTAINING MINERAL ADDITIVES AND RESPECTIVE PREPARATION PROCESS

(71) Applicant: AGRO UP AGRICULTURA E AGROINDUSTRIA LTDA, Tarumã (BR)

(72) Inventor: Yuri CUNHA, Curitiba (BR)

(21) Appl. No.: 17/635,828

(22) PCT Filed: Jul. 21, 2020
(86) PCT No.: PCT/BR2020/050275

§ 371 Date: Feb. 16, 2022

(30) Foreign Application Priority Data
Aug. 16, 2019 (BR) 1020190171340

(51) Int. Cl. C02F 11/00; B09B 3/25; C05F 7/00

(52) U.S. Cl. CPC C02F 11/008; B09B 3/25; C05F 7/00

(57) ABSTRACT

A granulated formulation formed from ETA (Water Treatment Plant) sludge and minerals from magmatic and/or sedimentary and/or metamorphic rocks, rich in magnesium and potassium silicates in addition to silicon dioxide and other components, representing an innovation in waste recycling processes for environmental purposes, the replacement of animal substrates by the proposed product and soil nutrient recycling process through generation of organomineral fertilizer resulting from exposure of the substrate to waste from creations in which it is used.

### FIELD OF APPLICATION

This invention pertains to the field of agriculture and livestock, chemical engineering, environmental engineering and human needs, notably water treatment, housing and floor coverings for animal husbandry housing and bedding for laboratory animals and, finally, of additives, fertilizers and soil enhancers.

### INTRODUCTION

This invention relates to a composition of water treatment plant sludge granulated with mineral additives comprising ETA sludge (water treatment plant) as a support material, which will undergo drying and granulation, with or without addition of metamorphic rocks and/or sedimentary and/or magmatic, for later use as chicken litter, corral, vivarium and which, after this use, can be used as fertilizer and/or soil conditioner for agriculture.

Furthermore, this invention also relates to a process for preparing this water treatment plant sludge composition to be granulated with mineral additives.

### Fundamentals and State of the Technique

The material that, remaining on the floor of a breeding facility, will receive excreta, feed scraps and other residues is called a bed or layer. Continuous contact of the bird or other animal with the bedding requires that the material used has adequate qualities to modify the characteristics of the environment, providing comfort to the animals, so as to avoid temperature fluctuations inside the facility and direct contact of animals with feces and with the floor.

The material considered must absorb the moisture from the floor and dilute the excreta to facilitate management practices that maximize the useful life of the bed and its subsequent use at the end of breeding. The determinations, seeking ecological preservation, lead to a reduction in the availability of materials commonly used with the purpose of serving as bedding, especially wood shavings (shavings) which tend to become scarce.

The ETA sludge, as it is basically clays, silicates and a small percentage of flocculating agents, serves as a “hardening agent” (according to IN MAPA n° 46 of 11/2006—Annex III), in the granulation process of fertilizers and correctives reducing the production cost. With the proposed technology there is elimination of pathogens and significant reduction of moisture and waste volume, and through the inherent alkalinization processes of the raw material to be mixed (blend) with the aforementioned minerals, precipitation of metals in the soil solution is expected, when this is used in farming.

### Sludge:

Controlling water pollution is essential for human health, as well as for the environment in which it is inserted. An important environmental issue that is currently being researched, and one of the main problems faced by large urban centers, is the final disposal process for the sludge generated in the water treatment plants (ETA). With population growth, drinking water consumption has increased, making it necessary to treat a greater flow of water to supply the entire population's demand.

According to specialists, the sludge is generated in two ways: first, due to sedimentation of flakes that occurs in decanters, where they are retained for days or even months, depending on the discharge system. And the other way of sludge production is due to the part of flakes that did not settle in decanters, and that go on to the step for filtration, where they are retained. During the cleaning of decanters, by mechanized or manual processes, and of filters through washing, the sludge is removed and sent to the dehydration and disposal process. Thus, sludge generation occurs in decanters and in filter washing.

In Brazil, most stations dispose of their waste without any form of treatment, directly into the water body closest to the station, causing siltation and deterioration of water quality in rivers and lakes. Currently, it is necessary to carry out new searches for sludge treatment technologies and to determine different forms of disposal, in order to cause the least possible impact on the environment and comply with environmental legislation (Available at https://qualidadeonline.wordpress.com/2015/07/14/tratamento-e-disposicao-do-lodo-de-eta-e-impactos-na-qualidade-das-aguas—accessed on Jul. 9, 2019 at 01:42 pm).

Much research has been carried out on the options for disposal of ETA sludge, such as: input in agriculture, disposal in landfill, incineration, use in the manufacture of ceramics, recovery of degraded area and recovery of coagulant. However, there are still gaps on the best way to dispose of this waste, in a way that causes the least possible environmental impact.

The waste generated in ETAs, according to specialists, is characterized by having high humidity, generally greater than 95%, being, in general, in a fluid form. Reduction of its volume provides a more adequate disposal, reduction in the cost of transport and final disposal, in addition to minimizing environmental pollution risks.

In Brazil, the greatest concern has been in relation to waste generated in sewage treatment plants (ETEs), while little has been discussed in relation to waste generated in ETAs, such as sludge. According to NBR 10.004, sludge is classified as solid waste, not allowing its release in natura in surface waters, promoting different environmental impacts. According to IBGE (2010), of the 5,564 Brazilian municipalities, 2,098 produce sludge in the water treatment process. Note that the percentage of Brazilian municipalities that dispose of sludge in rivers corresponds to 62.44%. Such percentage shows that a large volume of sludge has been released into rivers. However, in Brazil this practice is carried out by the majority of Brazilian water treatment systems, which interferes with the quality of water and can cause different impacts. Among the municipalities that dispose of the generated sludge into rivers, the Southeast region is the one that contributes with the largest number of municipalities, followed by the South region. These two regions are the ones with the greatest demand for water and consequently the ones that produce the greatest amount of treated water and sludge. According to Prof. Dr. Cali Laguna Achon from the Department of Civil Engineering at the Federal University of São Carlos, in a study carried out on the 23 ETA in the sub-basin of the Piracicaba river in Sao Paulo, which is a precursor in the management of water resources, the prevailing form of destination is the in natura disposal of the sludge in water bodies, with 73% of the sludge being released into the receiving bodies without prior treatment, 23% of the ETAs did not provide this information and only 4% send the sludge to landfill, after dewatering. Also according to the researcher, the information on the sludge generated in most of the ETAs is not even effectively measured and quantified, which makes it difficult to improve management of these wastes and assessment of environmental impacts arising from inadequate disposal.

It is clear from the words above that the volume of ETA sludge generated in Brazilian cities is large, combined with the few alternatives for destination, makes this waste an important environmental problem to be solved (According to Abner Figueiredo Neto, Master's thesis 2011 Federal University of Goiás).

Andreoli et al. (2006) highlights that in relation to the organic matter index, sludge is generally characterized by a low amount of organic compounds, which will depend on raw water, which can vary from 5% to 25%. It also observes the existence of some ETA sludge with a rich amount of organic matter and emphasizes that organic matter content present in sludge, in general, is greater than the content present in soil.

The pathogens found in sludge are considered low compared to soil and sewage sludge. According to Andreoli et al. (2006), considering the low levels of sanitary contamination, the conclusion is that this residue presents a low risk of environmental and sanitary contamination for populations” (Available at https://repositorio.bc.ufg.br/tede/bitstream/tde/618/1/DissertacaoAbneFiguei redoNeto.pdf accessed on Jul. 9, 2019 at 2:38 pm).

### Use of ETA Sludge in Agriculture:

Although scarce, some works on the use of ETA sludge in agriculture can be found.

At the 21st Municipal Sanitation Experience Exhibition held from June 19 to 22, 2019 in Campinas/SP, more specifically in the lecture “Application of ETA sludge in Agricultural Crops”, carried out by researcher Dr. Regina Teresa Rosim Monteiro from ESALQ/Piracicaba/SP, we have:

At the conclusion of the lecture, Dr. Regina says, “Treated ETA sludge has shown promise for being applied as a fertilizer or used as a substrate. Thus, it ceases to be a source of pollution and gains value, providing sustainability to its disposal in the environment (Available on the website https://slideplayer.com.br/slide/12005544/ accessed on Jul. 9, 2019 at 6:28 pm).

Another work that can be cited is the one presented at the V International Seminar on Environmental Sciences and Sustainability in Amazônia, from August 14th to 17th, 2018, at the University Campus of UFAM, whose title was “Use of Sludge from the Water Treatment Plant (WTP) for the Growth of Forest and Fruit Seedlings” and whose conclusion we transcribe ipsis litteris: “In light of these results conclusions are that WTP sludge can be used as a substrate for the production of seedlings of fruit and forest species analyzed in this study” (Available at https://www.even3.com.br/anais/5sicasa/93480-aproveitamento-do-lodo-da-estacao-de-tratamento-de-agua-(eta)-para-crescimento-de-mudas-florestais-e-frutiferas/ accessed on Jul. 9, 2019 at 03:57 pm).

According to Cristina Alfama Costa in the presentation given at the VI Seminar on Clean Technologies, held from June 8th to 10th, 2015 at Salão Piratini/Hotel Continental/Porto Alegre-RS whose title was “Challenges and Opportunities in the Sustainable Disposal of ETA and ETE Sludges”. EMBRAPA develops two lines of research using ETA for agriculture, namely (i) EMBRAPA Grape and Wine Research Project—Incorporation of ETA sludge into Soil; and (ii) Research Project EMBRAPA—Incorporation in the WTS Soil, product development and compositions with other waste from agriculture and mining (available at https://www.abes-rs.org.br/novo/_materiais/materiais_i8jw5n9wshpl .pdf accessed on Jul. 9, 2019 at 4:00 pm).

Reneu Abraão in his work presented for the discipline Project in Rural Sciences, whose title was “Application of sludge from a water treatment plant in the growth of Salvia officinalis”, presented in June 2016 in Curitibanos-SC. Due to the progress of the work, he predicts that “The use of ETA sludge should provide an increase in the values of phosphorus, potassium, calcium, magnesium, CTC, base saturation and organic matter in the soil to depths of 0.00-0, 20 m, therefore, should provide a better development in the root system of Salvia officinalis and consequently, a greater growth of the aerial part” (Available at https://repositorio.ufsc.br/bitstream/handle/123456789/165028/Reneu %20A bra % C3% A3o.pdf?sequence=1&isAllowed=y accessed on Jul. 9, 2019 at 5:32 pm).

At the 21st Brazilian Congress of Sanitary and Environmental Engineering, researchers Milton Tomoyuki Tsutiya and Angélica Yumi Hirata in the presentation “Use and Final Disposal of Sludge from Water Treatment Plants in the State of Sao Paulo”, discuss, among other uses for sludge from ETA, commercial grass cultivation and commercial soil. Let's see what they think: commercial grass cultivation includes gardening grass, fields for sports activities, parks, cemeteries and highway gardening, and is usually carried out in 5 steps: soil preparation, sowing, grass growing, harvesting and transport. ETA sludges can be applied in the liquid phase or after dehydration. Liquid sludge can be applied both in the soil preparation phase and in the turf growth phase. The pie can be applied in the soil preparation phase. Pilot demonstration studies must be carried out to determine the most suitable application dosage, taking into account the accumulation of metals in the soil, nutrient absorption, as well as the solids content for liquid application of the sludge, so that in the soil preparation, the moisture does not exceed the adequate moisture, and so that in the growing phase, solids do not cover the leaves, impairing photosynthesis. The application of ETA sludge in the cultivation of grasses increases the aeration and the water retention capacity in the soil, and also provides additional nutrients to the plants.

The use of ETA sludge in the production of commercial soils and potting soils has become increasingly common throughout the world. A wide variety of raw materials are required for commercial soil production. Typically, these components include perlite (for aeration), limestone (for pH adjustment), sand (weight), bentonite clay (buffering agent), peat, wood chips, and fertilizers (N and P). ETA sludge has been used to replace some of the components typically used in the production of commercial soils, such as perlite, limestone, sand and bentonite clay. In addition to these advantages, ETA sludge is used for soil structural improvement, pH adjustment, addition of trace minerals, increased water retention capacity and improved soil aeration conditions. Normally, this use requires sludge with a solid concentration of 40 to 60%. The sludge from ETAs, too, has been used in the manufacture of organic fertilizers, to increase weight. Another application that has been highlighted is its use as a support soil for seed germination.

Given the above, the possibility of using ETA sludge for agriculture is evident (Available at http://www.bvsde.paho.org/bvsaidis/caliagua/brasil/i-025.pdf accessed on 07/09/09 2019 at 6:34 pm).

### From the Chicken Bed

According to Valdir Silveira de Ávila, Helenice Mazzuco and Élsio Antonio Pereira de Figueiredo in Technical Circular No. 16 EMBRAPA CNPSA—National Center for Research of Swine and Poultry, the national poultry industry has developed rapidly in the last 30 years, placing Brazil as the second world exporter of broilers. This development was based on advances obtained in genetic improvement, nutrition, health, management, installation and equipment. One of the biggest obstacles in this area is the lack of knowledge of the most appropriate materials to be used as aviary bedding, as well as their respective properties. Bed is deemed as all material distributed in a shed or stable to serve as bedding for animals. More specifically, the material that, remains on the floor of a poultry facility, receiving excreta, feed scraps and feathers is called a bed or layer. Continuous contact of the bird with the bedding requires that the material used has adequate qualities to modify the characteristics of the environment, providing comfort to the animals, so as to avoid temperature fluctuations inside the facility and direct contact of birds with feces and with the floor. The material considered must absorb the moisture from the floor and dilute the excreta to facilitate management practices that maximize the useful life of the bed and its subsequent use at the end of breeding. The determinations, seeking ecological preservation, lead to a reduction in the availability of materials commonly used with the purpose of serving as bedding, especially wood shavings (shavings) which tend to become scarce. It is, therefore, essential and urgent to search for alternative materials and to adopt the practice of reusing the bed in the creation of subsequent batches. Aiming to inform about the capacity and availability of materials found in Brazil for aviary litter, this publication is intended to suggest the alternative materials and management practices necessary so that they can be used and reused, meeting the requirements of birds for their maximum performance. Furthermore, the possibilities of using poultry litter in animal feed and as a fertilizer are also described.

The materials used for poultry litter consist of industrial by-products, crop residues, most produced on the property or purchased from producing regions. The quality of the material used will decisively reflect the sanitary conditions of the lot. A quality bed must have desirable properties such as:
be of medium size;
be able to absorb moisture without binding;
easily release absorbed moisture into the air;
have low thermal conductivity;
have damping capacity, even under high density; and
have low cost and high availability.

### Materials Traditionally Used as Chicken Bed/Aviary:

The materials traditionally used for chicken bedding are:
Wood shavings;
Waste from industrial wood processing;
Sawdust;
Crushed corn cob;
Rice, peanut, coffee and bean husks;
Crop straws in general;
Grass hays;
Cassava bunch;
Waste from sugar cane industries and other products;
Paper recycling; (Available at https://ainfo.cnptia.embrapa.br/digital/bitstream/item/67877/1/CUsersPiazzonDocumentsProntosCNPSA-DOCUMENTOS-16-CAMA-DE-AVIARIO-MATERIAIS-REUTILIZACAO-USO-COMO-ALIMENTO-E-FERTILIZANTE-FL-12.pdf accessed on Jul. 9, 2019 at 8:12 pm).

### Main Problems of Traditional Chicken Beds

Bedding quality can directly influence the lot productivity, because when the lot is created under a good quality bed, it is less susceptible to sanitary problems. Dermatitis, ulcerations of foot pad and breast calluses, for example, are conditions directly linked to poor bedding quality. The conditions of the bird's foot pad have been proposed as one of the best indicators of bird welfare. In the future, the severity of dermatitis present in the foot pad will determine the housing density for chickens.

### Bacteria:

Chicken bed, combined with factors such as pH, water activity and temperature, constitutes a favorable environment for the development of several bacterial groups.

The presence of bacteria in litter is unavoidable and among the problems arising from its presence in high concentrations, one can cite the contamination of the natural environment, infections in chickens and greater contamination of the digestive tract by unwanted bacteria, resulting in greater contamination of the resulting products from the slaughterhouse. It is known that the presence and metabolism of microorganisms present in litter are accompanied by heat production, CO2 release and ammonia formation.

Among the bacteria present in litter, aerobic and microaerophilic bacteria are found in greater amounts. Among the most frequent Gram-positives and Gram-negatives are Lactobacillus sp and Escherichia coli, respectively.

According to Rehdeger (2002) the great diversity of bacteria present in litter can be divided into (i) bacteria that do not represent a direct risk to animal health, but that influence litter conditions, consisting of the most numerically expressive group and (ii) primary pathogens and secondaries from birds or the diners for birds, but potential pathogens for humans.

Non-pathogenic organisms, group one, participate in complex processes of recycling nutrients excreted by birds, such as those that act on the decomposition of uric acid resulting in ammonia, and proteolytics that produce enzymes (proteases) that break down excreta proteins.

Group two, however, is the group of interest when considering microbiological risks of bedding reuse, especially zoonotic agents, due to their implications for public health. Salmonella and Campylobacter, especially Campylobacter jejuni are among the most relevant agents involved in food safety. Bacteria such as Escherichia coli and Staphylococcus aureus, Clostridium perfringens, among others, can also be present in bedding and act as opportunistic pathogens or food contaminants (Fiorentin, 2005).

### Ammonia:

Another point that must be analyzed is the amount of ammonia (NH3) existing inside the aviary and in the bedding, which is also a harmful substance for birds.

### Rodents:

In broiler production rodents can easily consume, spread or spoil by contamination 10% of the total feed for the birds. In chicks they can attack the chicks, becoming carnivores and causing great losses. Rodents still cause damage to structures, equipment, such as curtains, water pipes and others. More important than what they consume is the food they contaminate with feces, urine and hair.

One of the most important impacts on animal and human health caused by rodents is their potential for disease transmission. Among the main diseases carried by rodents, salmonellosis stands out, which has a high impact on the creation of broiler chickens, in addition to infectious coryza, coccidiosis, among others. If the risks for the human population are considered, bubonic plague, leptospirosis and hantavirus (hemorrhagic disease, almost always fatal, transmitted by rodents).

There are two main genera of rodents (Mus and Rattus) that are home to the three most important species of synanthropic rodents: Mus musculus, Rattus norvergicu and Rattus rattus, which correspond, respectively, to the mouse, the rat and the roof rat. It is possible to find the three species cohabiting in the same habitat. These animals belong to the order Rodentia, as their central incisor teeth are adapted for gnawing, and therefore they grow constantly during the animal's life. For these teeth to remain functional, they need to undergo continuous wear, and in this way the animals gnaw structures to wear them out, even if it is not for food.

The Mus musculus or mouse is a small animal, measuring about 18 cm and weighing between 10 to 21 grams. The length of the tail is slightly longer than the length of the body.

Rattus rattus or roof rat is larger than the mouse, measuring about 38 cm and weighing from 80 to 300 grams. The tail is longer than the length of the body to the head.

Rattus novergicus, popularly known as rat or gabiru, is the largest of these 3 synanthropic rodents, weighing 120 to 500 grams and measuring about 45 cm in length, with the length of the tail being less than the length of the body to the head.

### Cascudinho Beetle:

Another important pest in poultry farming, perhaps the most important today, mainly due to problems related to poultry health, is Alphitobius diaperinus, also known as cascudinho. It is a small, black beetle that has a life cycle of 89 days. They are coleoptera originating from the African continent. The temperature between 21 and 33° C. is ideal for the development of this insect. The cascudinho feeds on leftovers of feed, dying birds, corpses and feces.

As it is a place where these insects are sheltered from light and birds, and have an abundant food source, they can be found in large quantities under the feeders. These beetles are vectors of many diseases, among those already proven, salmonellosis stands out. Even after cleaning the aviary, if the infected husks come back in the next batch's bedding, the bacteria can also return with them. Other agents such as Clostridium perfringens, Eimeria sp, Escherichia coli, Campylobacte sp, Bacillus sp, Streptococcus sp, Aspergillus sp and viruses such as Marek's Disease, Influenza, Gumboro, Newcastle, rotavirus and enterovirus can also be carried. The cascudinho is also considered a vector for avian leukosis (available at https://www.agencia.cnptia.embrapa.br/gestor/frango_de_corte/arvore/CON T000fc6egldw02wx5eo0a2ndxyjbu47oo.html accessed on Jul. 10, 2019 at 9:33 am).

### Traditional Chicken Bed Used as Fertilizer in Agriculture

According to Juliano Corulli Corrêa and Marcelo Miele, it is public and technical-scientific knowledge that fertilization with poultry litter, when used correctly, promotes great potential for agricultural production, and can be used in crops that produce grain, horticulture, fruit, pasture, reforestation and recovery of degraded areas. This is due to the chemical, physical and microbiological benefits it provides to the soil. However, respect for the environment must prevail over the objectives of increasing crop productivity.

With the application of bird litter correctly and for long periods, it is possible to observe the occurrence of improvements in the attributes of the soil, increasing its fertility, and most of these benefits are attributed to organic matter, which influences all properties of soil, such as: increased cation exchange capacity; availability and cycling of nutrients for crops; and complexation of toxic elements and micronutrients. These are fundamental factors in tropical soils, highly weathered and acidic (SANTOS; CAMARGO, 1999), in addition to providing an improvement in the structure, characterized by a decrease in soil density, increased porosity and water infiltration rate. There is also the gain of directly and indirectly increasing the capacity of the soil to store water (KIEHL, 1985).

It is still possible to infer about the presence of micronutrients and compounds such as humic acid, fulvic acid, fatty acids, which can allow the complexation of nutrients, gradually making them available to plants, mainly avoiding the fixation of P to the sesquioxides of Fe and Al from the soil, as well as the gradual release of N to the plants, since this has to undergo mineralization by soil micro-organisms before it can be used. Thus, fertilization with organic fertilizer made up of poultry litter goes far beyond the availability of N, P and K to plants.

Chicken litter can also have indirect effects, such as changes in the physical properties of the soil, which, in turn, improve the root environment and stimulate plant development. As organic matter, it allows aggregation of particles and stabilization of aggregates, which results in greater porosity, aeration and water retention (RAIJ et al 1991). In this way, it is important to provide readers with the technical criteria that must be taken into account in the application of poultry litter for agricultural and forestry production systems, aiming not only at increasing crop productivity, but, above all, at the rational use of this fertilizer organic. This practice must be understood within the concept of sustainable development, with socio-environmental responsibility, with the generation of income through agriculture and nature preservation for future generations (Available on the website https://www.alice.cnptia.embrapa.br/alice/bitstream/doc/920818/1/acamade aveseosaspcteos.pdf accessed on Jul. 10, 2019 at 11:23 am).

The residues from the intensive rearing of broilers, called chicken litter, are rich in nutrients and because they are available on the properties at a low cost, they can be made viable by producers in the fertilization of commercial crops (COSTA et al., 2009).

Agricultural use of poultry litter, mainly in corn cultivation, is a relatively old practice in Brazil, especially in the southern states of Brazil, where poultry farming occupies a prominent place in the economy of these regions. The interest in using bedding is due not only to the organic matter it adds to the soil, but also to the set of essential plant nutrients that are contained in it, which improves the qualitative aspects of the soil, highlighting the functions related to macro and microorganisms (BALLEM 2011).

The poultry aviary bed is designated as being all the material that is available on the floor of the sheds serving as a bed for birds raised for a period of time, this has in its concentration a mixture between bird excreta, feathers, feed, and the material that is initially used on the floor. Among the materials used as bedding, wood shavings, peanut husks, rice husks, coffee husks, dry grass, chopped corn on the cob, among others, can be mentioned (FUKAYAMA 2009).

According to Blum et al. (2003) poultry bedding becomes a good source of soil nutrients when properly managed, being able to partially or totally supply the chemical fertilizer in the crop. The addition of organic fertilizer obtained from chicken litter can contribute to improving the physical, chemical and biological characteristics of the soil (VALADÃO et al., 2011) (Available on the website http://folhaagricola.com.br/noticia/eficiencia-da-cama-de-aviario-de-frango-de-corte-na-agricultura accessed on Jul. 10, 2019 at 12:56 pm).

From the above argumentation, it is inferred that the use of traditional chicken/poultry litter is a common and advantageous practice for Brazilian agriculture.

### Corral Manure

When cattle ingest the feed, it does not absorb all the nutrients it has. So, cattle feces have a high amount of elements that are nutrients for the soil. It has a large amount of nitrogen, potassium, phosphorus and other elements, in addition to a large amount of microflora and microorganisms that improve the structure of the soil (Available at http://g1.globo.com/economia/agronegocios/globo-rural/noticia/2017/08/esterco-tratado-vira-fertilizante-e-evita-contaminacao-de-nascentes-de-agua.html Accessed on Jul. 16, 2019 at 11:02 am).

How can I prevent organic manure from losing nitrogen in the form of ammonia volatilization? Spread on the floor: ash, charcoal, natural phosphates, thermophosphates, gypsum, simple superphosphate, etc. In the case of stables and breeding, apply plaster before placing the beds, which can be: 1.0 to 1.5 kg/horse; 1 to 2 kg/beef; 0.5 kg/pig and 100 to 200 grams/hen. During the fermentation or curing process, maintain adequate humidity and mix materials that combine with ammonia, preventing its volatilization. The fresh manure, straw may also be mixed or argillaceous earths, spread in thin layers, in manure to ferment (https://www.ebah.com.br/content/ABAAABXHcAF/adubacao-organica-esterco-curado Accessed on Jul. 16, 2019 at 12:33 pm).

### Bioterium

A bioterium is a place where animals are bred and/or kept for later use in scientific experiments, especially in the case of rodents, frogs, rabbits and insects (https://pt.wikipedia.org/wiki/Biot % C3% A9rio, accessed on Jul. 13, 2019 at 9:18 am).

Bioteriums are facilities capable of producing and maintaining animal species for research in different areas of science. Regardless of the species or strain used, it is important that the handling and maintenance of laboratory animals are in accordance with ethical principles in animal experimentation. Care for the environment and microenvironment, as well as the sanitary conditions of the vivarium, are essential for not interfering in the research results.

It is necessary to encourage researchers to unify efforts for the implementation of sectorial bioterium in the institution, aiming at optimizing spaces and human and financial resources for the maintenance of animals. Thus, research institutions must invest in the construction and maintenance of animal breeding and experimentation facilities, with the aim of promoting the development of science and technology, with direct effects on public health (https://periodicos.furg.br/vittalle/article/view/941 Accessed 7/13/20149 at 9:19 am).

The animals are kept in cages in which the floor is covered with a layer of wood shavings (chipped wood shavings), rice husk, dehydrated sugarcane bagasse, corn cob or other product, depending on how easy it is to obtain and of the cost. Whatever the material chosen for the litter, it must be ensured that the plants that gave rise to them did not receive insecticides during cultivation. The material used for ‘bed’ is intended to absorb the animals' urine and water spilled inside the cage, keeping its bottom always dry, as well as serving as a thermal insulator to reduce the conduction of heat from the animals' bodies through the bottom of the cage. The material used for the ‘bed’ of the animals must have the following characteristics: be innocuous, that is, not having been treated with toxic substances; not coming from resinous woods; having high absorption power; allowing thermal insulation—the insulating properties decrease with increasing humidity; of well-being; be odorless; be easily disposable—it is advantageous that the material can be incinerated, as the ‘bed’ may be contaminated (chemically or biologically); be easily transported, handled and stored (appropriate packaging for these purposes) (http://books.scielo.org/id/sfwtj/pdf/andrade-9788575413869-08.pdf Accessed on Jul. 13, 2019 at 9:34 am).

### General Granulation Process

In the production of granulated fertilizers, inputs (water, steam, raw materials, etc.) are dosed in equipment called a granulator, which aims to adapt the product to chemical specifications and increase the particle size to a desired standard (between 2 and 4 mm). After granulation comes the drying process, which is responsible for removing volatile substances (water) used in the granulation process. Granulation is the process by which very fine powder particles adhere to each other to form a larger particle, which in reality are multi-particles called granules (BERNARDES, 2006).

In Brazil, the term granulation is often used to generalize all types of operations in the field of “Size Increase” and for the fertilizer sector specifically, it represents the possibility of concentrating in the same granule and uniformly both the amount of weight how much in nutrients from the main raw materials: nitrogen, phosphorus and potassium. One of the ways to prevent or minimize the effects of hydroscopicity in fertilizers is granulation, by increasing the size of the granules (ALCARDE et al., 1992). The methods for granulation can be divided into 2 groups: wet route (uses some type of liquid in the process) or dry route. Regardless of the technological route used for the production of organomineral fertilizers, after the treatment of waste (physical or by the composting method), the fertilizers can be subjected to the process of granulation, drying and standardization. (http://cassiopea.ipt.br/teses/2016_PI_Susana_Gazire.pdf Accessed on Jul. 13, 2019 at 10:16 am).

### Patent State of the Art

One of the related patent documents of the relevant state of the art is represented by the Brazilian patent application number BR102017011655-7, which discloses and describes a composition for adsorption of phosphorus and/or nitrogen from effluents or liquid waste, comprising at least one material of support, preferably serpentinite, vermiculite, charcoal (modified by oxidative treatments or not) and/or sludge from a phosphate-rich effluent treatment plant; such support material being impregnated with calcium, zinc, copper, manganese, molybdenum, boron, cobalt and/or nickel; and calcined. It also deals with the use of the composition, the process for preparing the composition, the process for producing additives for soil conditioning and nutrient release, devices for the recovery of phosphorus and/or nitrogen, and the additives produced.

As can be easily inferred from the reading of BR102017011655-7, said document is intended for the extraction of phosphates and/or nitrogen from effluents and/or liquid waste, with ETE waste being just one of the ingredients for the claimed composition, with neither the prediction nor the suggestion of joining an ETA residue with another mineral aiming at the subsequent adsorption of nutrients from a chicken litter or corrals or animal houses.

In addition, the aforementioned prior art process describes, in addition to the impregnation of the support material with calcium, zinc, copper, manganese, molybdenum, boron, cobalt and/or nickel, also the use of acids which, in any of the conditions, makes the composition unsuitable for use in chicken litter or pens or animal houses.

### Conclusions Regarding State of the Art

As can be inferred from the above description, there is, on the one hand, the environmental problem that represents the generation of ETA sludge due to the enormous volume produced in the stations, as well as the extreme lack of known environmentally correct destinations. On the other hand, we have a growing poultry production, with all the common bottlenecks of the activity, the main problem being the diseases that the traditional materials used in poultry litter bring.

It is evident from the above analyzes and studies that the market lacks a solution capable of eliminating at once these two sides of the problem, one environmental and the other sanitary, maintaining an already existing advantage, which is the use of the final product (chicken litter/pen/vivarium) as fertilizer for agriculture.

The current technique lacks a solution to minimize an environmental liability (WTP sludge), capable of being used in order to make the litter in animal husbandry healthier, and still maintaining the gain of having its traditional use in agriculture.

There is, therefore, room for a solution that overcomes the deficiencies of the state of the art and that, in particular, comprises and provides the following characteristics and advantages:
Decrease in the volume of WTP sludge that is incorrectly disposed of, usually in rivers, an unfortunately common practice in Brazil;
Transformation of what is currently an environmental liability into an environmental asset;
Improvement in waste disposal logistics;
Improvement of sanitary conditions (chemical and physical) in the rearing of poultry/cattle/guinea pigs, since the residues traditionally used present a series of restrictions to the health of the animals;]
Improvement in sanitary conditions is due to the better physical characteristics of the new product used;
Less infestation/proliferation of pests and diseases;
Promotion of greater animal welfare by absorbing toxic gases (ammonia) in animal confinement areas, improving thermal comfort, thus increasing the productivity of creations;
Increased efficiency as a liquid absorbent (slurry) compared to those traditionally used;
Accelerates the decomposition of animal excrement residues and food waste;
The possibility of using a product that has better characteristics (than the traditional ones) as a soil conditioner, both in chemical and physical terms, which will result in an increase in crop productivity;
Greater added value in chicken litter/pen if the breeder, not being a farmer, chooses to sell it; and
Understand a by-product that improves the chemical, physical and biological conditions of the soil, when in doses and according to the qualified technician's recommendations, and may even reduce or even eliminate the use of chemical fertilizers.

### Purposes of the Invention

One of the objectives of the present invention is to provide a composition according to the characteristics of claim 1.

Another objective is the use of the product resulting from the industrial process in the animal and agricultural production chain.

### DETAILED DESCRIPTION OF THE INVENTION

This invention foresees the use of WTP sludge dewatered (in a blast furnace) and granulated (granulator/mixer) with the addition of minerals that have desirable agronomic characteristics, whether chemical or physical. The desirable chemical characteristics in the minerals that can be added are those related to the nutrients needed for the crop. The physical characteristics are those that added to the granule may give it a greater water retention capacity or other advantage, helping the WTP residue in this function and, consequently, the crop when it is used for this purpose.

The WTP sludge, therefore, leaving the water treatment plant, must undergo drainage, granulation and mixing in the industry.

It is important to emphasize the technical/logistical non-viability of proceeding with a “pre-mix” of the mineral to be used (sedimentary/metamorphic/magmatic rock) at the sludge production site. Unfeasible due to the large volume of sludge produced per day, the facilities of the treatment plants are compact, as well as it is not the institutional object of the stations (usually public) as this is a different activity from the main one (water production), increasing costs etc.

Such mixing should, therefore, be done in industry, where the use of blast furnaces/granulators/mixers from a factory that performs such activity is the place for such a process. This action is important for the residue to undergo the necessary discharge, since the in natura residue presents an average of 80% humidity in its composition at the exit of the treatment plant.

The idea is that during dewatering, the water contained is largely eliminated, and as such waste is basically composed of clay and silt, its water retention capacity is later resumed, this capacity will be maximized with the ore to be added.

The physical uniformity of the residue (granulation/mixture) is important, taking into account the animals' need for comfort. Greater comfort, greater effectiveness in production and subsequent use.

Such step (draining/granulation/mixing), as already said, is the appropriate time for the addition of other mineral elements/fertilizers in the granule, such minerals to be added will be defined largely according to the need/use that will be given later, the chicken/poultry litter, as it will depend on the type of crop (coffee, corn, soy, pasture, etc.) always in line with the soil analysis of the place where such fertilizer will be applied and with the current legislation regarding metal indices heavy tolerated.

Bearing in mind the possibility of adding minerals to the ETA sludge granule, in order to improve its chemical and/or physical qualities for its subsequent use in agriculture, we have as examples the possibility of using sedimentary and/or magmatic and/or metamorphic rocks.

Sedimentary rocks: sedimentary rocks can be used to supplement the agricultural soil with nutrients, since, taking as an example the granulation with Diatomite (and not limited to this sedimentary rock), we have Diatomite as a good source of Si and Mg which, in addition, increases the moisture adsorption capacity. Other sedimentary rocks may be, but are not limited to, suitable Gypsum, Anhydrite and the like.

Magmatic rocks: aiming to supplement the agricultural soil with nutrients, magmatic rocks are also a good option. From magmatic rocks, taking as an example the granulation with Basalt (and not limited to just this magmatic rock, it could be another suitable similar chosen from the group of magmatic rocks), we will have Basalt as a good source of Si (presence of 45 to 50% in the rock), as well as more of 60 micro and macro other nutrients.

Metamorphic rocks: aiming to correct soil acidity, the use of metamorphic rocks is an excellent option, in addition to providing other nutrients for the agricultural culture. Of the metamorphic rocks, taking as an example the granulation with Serpentinite (and not limited to this metamorphic rock), in addition to the correction of acidity, we also have the input of Ca and Mg into the soil. Other metamorphic rocks may be, but are not limited to, suitable Phyllite and the like.

In addition, we also have the possibility of powder mixtures from rocks of different classes (metamorphic/sedimentary/magmatic), or even more than one rock powder of the same class.

As a non-limiting example of rock powder mixtures of different classes (metamorphic/sedimentary/magmatic), according to the invention, we can mention, in percentages by weight, a composition comprising between 10% and 80% of ETA Sludge and between 90% and 20% Serpentinite.

In a preferred embodiment not limiting the scope of the present invention, the composition comprises from 10% to 50%, preferably 30% of ETA Sludge, from 1% to 30%, preferably 10% of Diatomite, from 5% to 50%, preferably 35% Serpentinite, 5% to 40%, preferably 20% Filite and 1% to 15%, preferably 5% Basalt.

In another preferred embodiment not limiting the scope of the present invention, the composition comprises between 20% and 80%, preferably 60% of ETA Sludge and between 20% and 80%, preferably 40% of Diatomite.

In a preferred embodiment not limiting the scope of the present invention, the composition comprises from 10% to 50%, preferably 30% of ETA Sludge, from 1% to 15%, preferably 5% of Diatomite, from 20% to 60%, preferably 40% Serpentinite, 10% to 30%, preferably 20% Filite and finally 1% to 15%, preferably 5% Basalt.

In yet another preferred mode not limiting the scope of this invention, the composition comprises 5% to 30%, preferably 20% sludge, 30 to 70%, preferably 50% dehydrated calcium sulphate or Anhydrous and 10% to 50%, preferably 30% Serpentinite.

The composition according to the invention therefore comprises a granulated compound made of different silicates of magnesium and potassium and silicon dioxide, with a small organic fraction and silicate aluminum clays from the WTP (Water Treatment Plant), in addition to micro and macronutrients in different proportions, always obeying the parameters dictated by the composition of the residues or analysis of the WTP sludge to be used.

Macronutrients can be selected from, but not limited to, the group consisting of suitable potassium, phosphorus, magnesium, and the like.

Macronutrients can be selected from, but not limited to, the group consisting of suitable boron, molybdenum, zinc, magnesium, and the like.

The object of this patent can be considered a soil remineralizer, as it uses natural silicates in the form of serpentinite, phyllite, diatomaceous earth, gypsum/anhydrite of recognized agronomic effect, together with the WTP sludge that served as its base.

In terms of process, the best way of carrying out according to the invention comprises the processing of WTP sludge in ovens with high temperature that allow its efficient dewatering, passing these residues, as a result of the production process, through granulators/mixers with different systems (cylinder/rotating drum, inclined discs, tray, plate), with uniformity being the most important of particle size/mixture. After this step, the product can be sent to places of intermediate use (bed/corral/animal house), and, later, to farming.

The process starts with mixing the WPT sludge with one or more of the selected minerals. Such mixture will take place in the industry that will produce/granulate the product. It is unfeasible, but not technically impossible, to carry out such a mixture in the sludge production unit. The proportions of minerals vary according to several factors, including the cost of the raw material(s), the need of the aviculturist/farmer etc.

The raw materials will be received in lung silos with adequate capacity, and their supply will be carried out by a loader, where the material will be duly weighed according to the production order and then deposited in a horizontal paddle mixer. After the residence time for the mixture has elapsed, it goes by conveyor belt to the storage location in the manufacturing sector, in a duly identified box.

The granulation of the products will be carried out with a granulating plate and a starch solution will be used as an adhesive to agglomerate the particles in the granulation, giving physical stability to the finished product.

In the manufacturing sector, raw materials feed a lung silo that supplies the conveyor belt, which in turn feeds the granulating plates, where the granulation process will be carried out. In the granulating dishes, the raw material receives a spray of starch solution through a fan nozzle. After a period of residence of the material in the granulating plate, accompanied by the operator, the granules are formed.

The formed granules are unloaded on a conveyor and taken to the dryer cylinder, which carries out the drying process through high temperature, close to 700° C. at the dryer inlet and 150° C. at the dry material outlet. It is important to point out that, at this stage, due to the thermal process described above, pathogenic agents such as bacteria, fungi, viruses, as well as weed seeds are eliminated. Product sterilization occurs.

In the dryer cylinder, the drying process is carried out, in which the moisture content of the material should be approximately 1%, thus maintaining its physical stability and hardness level above 2 kgf.

When drying the material, the vapors generated in the dryer are suctioned by the exhaust system, formed by the hood, cyclone, exhaust ducts and particle washer, returning to production, forming a closed circuit.

The dry material is discharged into the hood by gravity and through ducts, to a bucket elevator, later transported to a rotating classification sieve. In the rotary sieve, the material is classified into stainless steel sieves with openings between 2.00 and 4.00 mm. After the classification process, the material goes through a conveyor belt to the finished product storage box, duly identified. Granules below 2.00 mm are returned to the granulating plates, with a return to drying and classification. Granules over 4.5 mm are fed to a hammer mill and returned for classification on the rotary sieve. The particulate material generated in the particle washing process is collected in specific bays and returned to production, as it is a simple mineral fertilizer production, not interfering with the quality of the product.

The effluent generated in the particle washer and decanted in the concreted bays is used as a water source and reused in the production system, thus forming a closed production circuit, without generation environmental liabilities of solid and liquid residues. Only water vapor is generated by the gas washer, coming from the washing process. The prevention of production failures is detected by collecting samples in the production at a pre-established frequency, where the granulometry and the degree of hardness will be analyzed. With these results, it is possible to evaluate how the process of granulation, drying and starch concentration is going. If necessary, flaws in the process can be immediately corrected, generating information to meet the technical indexes, embodied in the production process spreadsheet, aiming at dynamic adjustments to the production process.

The production will be monitored by collecting information from technical indexes, preferably with the items quantity produced per hour, consumption of raw materials, energy consumption, consumption of starch solution and temperature in the hood, amount of return in the production cycle. All these data will be noted in a production spreadsheet by work shift. The information from the technical indexes will generate information that makes it possible to track all material consumption in the production cycle and form a standard method for production. All occurrences in the production period will be reported in the “Production Report”, with the following information: date, batch number, product name, minimum guarantees, list of team components, collection of technical index information, occurrence of problems in production, time of occurrences and production stops, quantity produced, hours worked, etc.

It is important to consider that after the industrial mixing/granulation process, a certain amount of Diatomite can be used as QSP (sufficient amount to) improve the granules in the anti-caking aspect of the mixture, a property inherent to this mineral.

### Final Considerations

This invention describes a new and inventive composition used as an absorbent in its initial use in agriculture as a substrate disposed in breeding floors to absorb moisture from excreta and other waste in order to maintain comfort and animal health.

After using this material, it is transformed into fertilizer or as a filler or additive for mixing other complex fertilizers, especially when it has previously served for raising livestock and poultry.

The invention relates to a composition and a process for the preparation of a granular compound made of different silicates of magnesium and potassium and silicon dioxide, with a small organic fraction and silicate aluminum clays from WTP. (Water Treatment Station), in addition to micro and macro nutrients in varying proportions, all depending on the composition of waste or analysis of the WTP sludge that was used.

The object of this patent can be considered a soil remineralizer, as it uses natural silicates in the form of serpentinite, phyllite, diatomaceous earth, dehydrated calcium sulphate/anhydrous of recognized agronomic effect, together with the WTP sludge that served as its base.

In current technique, there is nothing similar to the invention, which is environmentally correct and gives flow to the volume of WTP generated, transforming an environmental liability into an environmental asset.

With the use of WTP sludge mixed with minerals in chicken litter/corral/vivarium, the problem in these activities is minimized.

The use of traditional waste (shavings, straw, sawdust, etc.) brings a series of health problems to the activities, such as the proliferation of bacteria, rodents (and their transmissible diseases), small husks, etc.

In the case of bacteria/fungi/viruses, the use of a mixture of minerals (WTP sludge+other minerals), as it is not an organic substrate, obviously minimizes the proliferation of such pathogens. Less pathogens, lower costs.

The minimization of pathogens will be largely due to the physical and chemical aspect of the finished product object of this patent, since wood shavings, straw, sawdust, etc. they have rough surfaces and insets and, thus, greater capacity to fix bacteria, fungi, etc. Such health advantages can certainly be computed as additional gains, by minimizing the use of insecticides, bactericides, etc.

In the case of cascudinho its proliferation is also minimized for the same reason mentioned above;

The moisture retention capacity will be given by the intrinsic characteristic of the residue (high clay/silt content), added to the capacity of the added mineral. It is also important to emphasize that there will be a percolation of moisture through the gaps between the granules;

In the case of rodents, their infestation tends to decrease, as they will have less food available. The organic substrate leaves and the mineral enters.

With the standardization of the chicken litter/corral/vivarium, with the granules, there will be greater comfort for the animals. Greater comfort, greater productivity.

Litter management is facilitated, since the movement of a chicken litter/pen with traditional waste (shavings/straw), has its difficulties increased, since the material intertwines with each other, worsening with deposition of the waste;

With such use, the sanitary problem is minimized and the handling of the substrate is improved.

With the use of WTP sludge+minerals in litter, the use of this substrate in chicken litter/pen/biotery as fertilizer for agriculture is improved.

The possibility of adding minerals (which add chemical and/or physical benefits to the soil) to the ETA sludge, when it is granulated, brings advantages in its use as a fertilizer. Since they fill fertility and/or physical gaps in the crop where they will be used;

The possibility of adding minerals in traditional beds is less efficient than the solution presented here;

The inclusion of interesting minerals for agriculture, whether by chemical or physical aspect of these, is shown as an advantage that must be computed. It is in the granulation/mixing that we can correct nutritional deficiencies in the soil where the chicken/barn/animal litter will be used as fertilizer.

The advantage of dispersion in the crop is facilitated, for the same reason listed above.

If the breeder is not a farmer, he can, even so, sell the substrate at more interesting values, since it is enriched by minerals useful for agriculture.

Greater retention of ammonia, compared to waste traditionally used and substantial gain in the cost/benefit ratio of the fertilizer resulting from the industrial process and after its use as a substrate.

### CONCLUSION

It will be easily understood by those skilled in the art that modifications can be made to the present invention without thereby departing from the concepts set out in the above description. Such modifications are to be considered within the scope of the present invention. Consequently, the particular embodiments described in detail above are only illustrative and exemplary and not limiting the scope of the present invention, which must be given the full extent of the appended claims and any and all equivalents thereof.

1. A composition of granulated water treatment station sludge with mineral additives, characterized for being granulated and comprising:
a. magnesium and potassium silicates;
b. of silicon dioxide, with a small organic fraction and silicate aluminum clays from water treatment plants);
c. micro and macro-nutrients; and
d. sedimentary and/or magmatic and/or metamorphic rocks.

2. The composition according to claim 1, wherein the macronutrients are selected, but not limited to, the group consisting of potassium, phosphorus, magnesium and the like.

3. The composition according to claim 1, wherein the macronutrients are selected, but not limited to, the group consisting of boron, molybdenum, zinc, magnesium and the like.

4. The composition according to claim 1, comprising, in percentages by weight, between 10% and 80% of WTP Sludge and between 90% and 20% of Serpentinite.

5. The composition according to claim 1 comprising 10% to 50%, preferably 30% of ETA Sludge, from 1% to 30%, preferably 10% of Diatomite, from 5% to 50%, preferably 35% Serpentinite, 5% to 40%, preferably 20% Filite and 1% to 15%, preferably 5% Basalt.

6. The composition according to claim 1, comprising, in percentages by weight, between 20% and 80%, preferably 60%, WTP Sludge and between 20% and 80%, preferably 40% of Diatomite.

7. The composition according to claim 1 comprising in weight percentages, 10% to 50%, preferably 30% of WTP Sludge, from 1% to 15%, preferably 5% of Diatomite, from 20% to 60%, preferably 40% Serpentinite, 10% to 30%, preferably 20% Filite and 1% to 15%, preferably 5% Basalt.

8. The composition, according to claim 1, comprising, in weight percentages, 5% to 30%, preferably 20% sludge, 30 to 70%, preferable 50% dehydrated calcium sulphate or anhydrous and 10% to 50%, preferable 30% Serpentinite.

9. The composition according to claim 1, characterized in that wherein the sedimentary rock is chosen from the group consisting of Diatomite, Gypsum, Anhydrite and the like, preferably being Diatomite.

10. The composition according to claim 1, wherein the magmatic rock is chosen from a group of magmatic rocks.

11. The composition according to claim 1, wherein the metamorphic rock is chosen from the group consisting of Serpentinite, Phyllite and the like.

12. A process for preparing a granulated water treatment plant sludge composition with mineral additives, for obtaining a preparation according to claim 1.

13. The composition according to claim 10, wherein the magmatic rock is Basalt.

14. The composition according to claim 11, wherein the metamorphic rock is Serpentinite.
